(19) United States
(12) Patent Application Publication
(10) Pub. No.: US 2007/0136140 A1
(43) Pub. Date: Jun. 14, 2007

(54) Provision of shopping information to mobile devices

(75) Inventor: Leonard Smith JR., Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/301,722

(22) Filed: Dec. 13, 2005

(51) Int. Cl. G06Q 30/00

(52) U.S. Cl. 705/26

(57) ABSTRACT

A system for communicating information relating to an item to a mobile unit comprises a search component that receives a request relating to the item from the mobile unit over an intranet and searches inventory of a plurality of merchants for information relating to the item. A communication component provides a subset of the information relating to the item and an option to consummate purchase of the item to the mobile unit, the subset of information includes details associated with physical location of the item.

### BACKGROUND

Advancements in networking and computing technologies have enabled transformation of computers from high cost devices capable of performing basic word processing tasks and performing basic mathematical computations to high performance/low cost machines capable of a myriad of disparate functions. For example, a consumer level computing device can be employed to aid a user in paying bills, tracking expenses, communicating nearly instantaneously with friends or family across large distances by way of email or instant message, obtaining information from networked data repositories, and numerous other functions/activities. Computers and peripherals associated therewith have thus become a staple in modern society, utilized for both personal and business activities.

Computing devices are now also commonly used for purchasing items by way of the Internet. For instance, an individual can access a web site associated with a particular retailer and locate an item that they desire to purchase. The item can be located through selection of one or more hyperlinks (that may be arranged in a hierarchical manner), through a search engine associated with the web site, or any other suitable manner for locating the item. An individual can then enter credit card information, debit card information, gift card information, or other payment information and effectuate purchase of the item. Thereafter, the retailer ships the purchased item to an address provided by the purchaser.

Shopping for items over the Internet has increased in popularity over the past several years. Rather than being subject to long lines at checkout counters, traffic associated with one or more retail establishments, locating parking, weather conditions, and the like, an individual can browse items and make purchases from the comfort of their own home. Further, the individual need not concern themselves with item availability, as many web sites associated with retailers can provide the individual with inventory information in real-time. Thus, with a few simple clicks of a mouse, a user can effectuate purchase of a desired item.

While there are several benefits associated with online shopping, there also exist various deficiencies. For example, one cannot accurately determine size, shape, and/or exact color of an item from a computer screen. For instance, a decorative item may appear to be a particular color on a computer screen (due to lighting associated with an image of the item). When reviewed in person by a prospective purchaser, however, the color of the item may be slightly different than anticipated, rendering the item undesirable. In another example, an individual may purchase clothing through a website, but upon receipt of such clothing it may not fit the individual as desired (e.g., a pair of shoes may be too small). Thus, the individual must wait several days to receive the clothing, suffer angst when determining that the clothing does not fit, and then return the item (often at the individual's expense). Thereafter, if still wishing to purchase an item through the website, the individual must repurchase the item and wait for the item to arrive, which may require several days (depending on the shipping method selected, location, etc.).

Shopping on-site at a retail store enables the individual to undertake a physical review of an item to be purchased, as well as enable the individual to instantaneously possess the purchased item. Therefore, if the individual is in immediate need of an item, physically traveling to a retail establishment may be necessary. Furthermore, individuals may be hesitant to purchase big-ticket items without physically inspecting the items prior to purchase. Like shopping over the Internet, shopping at a retail establishment is associated with various deficiencies. As stated above, the individual must travel to the retail store, thus subjecting themselves to traffic congestion. Further, oftentimes parking a vehicle at a retail establishment can be an unpleasant and stress-inducing experience, as parking spaces may be small, an amount of parking may be insufficient, and the like. Moreover, once inside a retail establishment, it is often quite difficult to locate an item that is desirably reviewed and/or purchased. Specifically, many of today's most popular stores are the size of warehouses, and may include multiple floors. If the individual is searching for one particular item, locating such item can be an extremely difficult task.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

The claimed subject matter relates generally to enhancing a shopping experience of a user through utilization of mobile units. In more detail, the claimed subject matter combines ease of shopping and quick access of information associated with shopping by way of the Internet with ability to inspect an item on-site prior to purchase, such as with conventional shopping. To effectuate this combination of benefits, an intranet that associates a plurality of merchants within a particular geographic region can be maintained. For example, a plurality of merchants within a shopping center can be included within one or more databases that are accessible by way of the intranet, wherein the database(s) can include merchant identification, items offered for sale by the merchants, location of the merchants, inventory associated with the merchants, and any other suitable data.

A request for an item that is sold by at least one of the merchants can be received by way of the intranet, wherein such request can be associated with a particular geographic location. In one example, the request can originate from a mobile unit that is proximate to at least one of the merchants associated with the intranet, wherein the mobile unit can be a mobile telephone, a personal digital assistant, an instant messaging device, etc. The one or more databases can be searched over based upon content of the request, and information relating to the item can be provided to a mobile unit associated with the request. Furthermore, an option to purchase the requested item can be provided to a user of the mobile unit, wherein the user can consummate purchase of the requested item by way of the mobile unit.

The information provided to the mobile unit can include identification of merchants that are offering the requested item for sale, prices associated with the items and the merchants, and availability of the items with respect to the merchants. Furthermore, the information can include a map and/or directions indicating location of a selected merchant and/or a precise location of the requested item. Thus, rather than being forced to search several merchants to locate a desired item and compare prices, item information and location can be quickly provided to a user associated with the mobile unit.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a high-level block diagram of a system that facilitates provision of information relating to an item to a mobile unit.

FIG. 2 is a block diagram of an inventory analysis system.

FIG. 3 is a block diagram of a system that facilitates purchasing an item by way of a mobile unit.

FIG. 4 is a block diagram of a system that facilitates implicit generation of a request for information relating to a desirably purchased or reviewed item.

FIG. 5 is a block diagram of a system that facilitates translation of voice commands into a request for information relating to an item.

FIG. 6 is a block diagram of a system that facilitates incorporating location of a mobile unit into a request for information of an item.

FIG. 7 is a representative flow diagram illustrating a methodology for providing information relating to an item to a mobile unit.

FIG. 8 is a representative flow diagram illustrating a methodology for providing information relating to an item to a mobile unit.

FIG. 9 is a representative flow diagram illustrating a methodology for providing a user with an option to purchase a requested item by way of a mobile unit.

FIG. 10 is a representative flow diagram illustrating a methodology for automatically generating an information request.

FIG. 11 illustrates a block diagram of an exemplary mobile unit.

FIG. 12 illustrates an exemplary environment in which features described herein can be employed.

FIG. 13 is an exemplary graphical user interface for displaying information relating to a requested item.

FIG. 14 is an exemplary graphical user interface for displaying information relating to a requested item.

FIG. 15 is a schematic block diagram illustrating a suitable operating environment.

FIG. 16 is a schematic block diagram of a sample-computing environment.

### DETAILED DESCRIPTION

The subject invention is now described with reference to the drawings, wherein like reference numerals are used to refer to like elements throughout. In the following description, for purposes of explanation, numerous specific details are set forth in order to provide a thorough understanding of the claimed subject matter. It may be evident, however, that such subject matter may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers. The word “exemplary” is used herein to mean serving as an example, instance, or illustration. Any aspect or design described herein as “exemplary” is not necessarily to be construed as preferred or advantageous over other aspects or designs.

Furthermore, aspects of the claimed subject matter may be implemented as a method, apparatus, or article of manufacture using standard programming and/or engineering techniques to produce software, firmware, hardware, or any combination thereof to control a computer to implement various aspects of the subject invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of what is described herein.

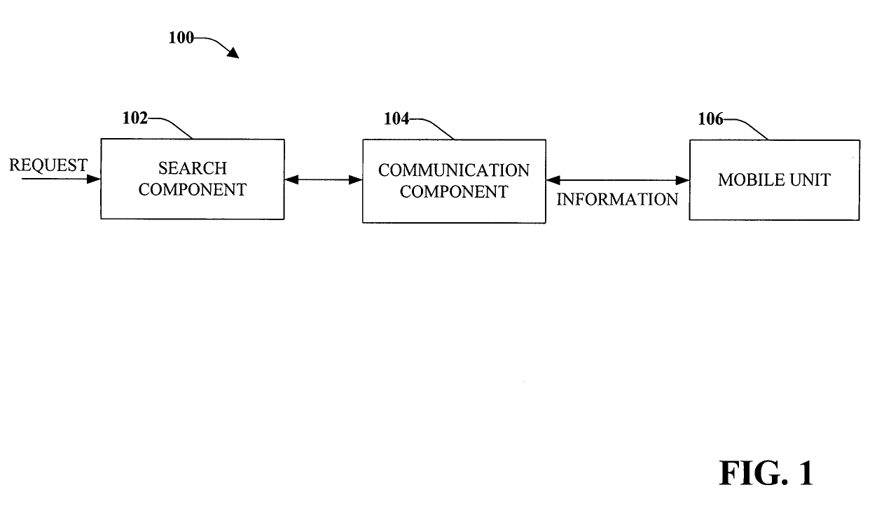

The claimed subject matter will now be described with respect to the drawings, where like numerals represent like elements throughout. Referring now to FIG. 1, a system 100 that facilitates shopping for an item is illustrated. As used herein, the term “item” is intended to encompass tangible and non-tangible products as well as services that are available for purchase. The system 100 enables advantages associated with online shopping and on-site shopping to be combined, thereby causing an individual's shopping experience to be more efficient and enjoyable. The system 100 includes a search component 102 that receives a request relating to an item that is offered for sale by one or more merchants over an intranet. In one example, the merchants can be geographically proximate to one another, such as within a shopping center. The request can be user-generated, for instance, through a personal computer, a kiosk at a retail establishment, a portable device such as a cellular phone, a personal digital assistant (PDA), a text-messaging device, an instant messaging device, or any suitable combination thereof. More particularly, the request can relate to an item that may be offered by a plurality of different merchants, wherein each of the merchants has registered with the system 100.

With more detail regarding the request, such request can be a text-based request generated through utilization of a keypad and/or a pressure-sensitive screen. In another example, the request can be generated through voice commands by way of a portable telephone. For instance, the cellular telephone can connect to the search component 102 by way of a browser associated with the cellular telephone, and thereafter a user can provide the request through voice commands. In another example, the user can dial a particular number associated with the search component 102 and provide the request through voice commands. Additionally or alternatively, a request received by the search component 102 can be implicitly generated based upon user context and/or user history. Implicit generation of a request is described in more detail infra. Still further, the request can be associated with geographic indicia, such as current location of the user and/or prospective location of the user. This information can be automatically obtained, for example, by a GPS sensor associated with the user, through identification of towers utilized to communicate with the user, etc. Further, location-based indicia can be explicitly provided by a user, such as an address of a shopping center.

The search component 102, given the request, can search through one or more databases associated with the plurality of merchants for information relating to the requested item. For example, the database(s) can include inventory information, geographic location associated with the merchants, geographic location associated with items offered for sale by the merchants, pricing information relating to the requested item, digital pictures of the requested item, and any other suitable information that can relate to items offered for sale. A communication component 104 associated with the search component 102 can analyze the information located by the search component 102 and provide a subset of the information to a mobile unit 106. For instance, the search component 102 and the communication component 104 can be resident upon a server that is associated with a plurality of merchants. The information provided to the mobile unit 106 can include an option to purchase the requested item over the intranet by way of the mobile unit 106. The term “intranet” as utilized herein is intended to encompass local area networks and wide area networks if content provided to a user is based at least in part upon location of such user. For example, a user that is geographically proximate to a first merchant or collection of merchants can be provided with different inventory/pricing when compared to a user that is geographically proximate to a second merchant or collection of merchants. Such information can be retained upon the Internet and selectively provided over a local area network or wide area network based upon user location.

In a detailed example, a user can be located at a shopping center that includes a plurality of merchants. The user can enter a request for a particular item, such as a certain pair of tennis shoes, into the mobile unit 106. Moreover, a physical location of the mobile unit 106 can be incorporated into the request. For instance, if the mobile unit 106 is outdoors, GPS sensors associated with the mobile unit 106 can be employed to determine location of the mobile unit 106, and such location can be incorporated into the request. In another example, if the mobile unit 106 is indoors, triangulation algorithms can be utilized to determine location of the mobile unit 106. In more detail, the mobile unit 106 can communicate with three or more separate antennas, and time of arrival of signals between the mobile unit 106 and the separate antennas can be employed to accurately locate the mobile unit 106.

The request and geographic information can be received by the search component 102 and utilized when performing a search of a database (not shown) of merchants to provide the mobile unit 106 with details relating to the requested pair of shoes. For example, the information can include merchants that sell the pair of shoes, price of the shoes with respect to each merchant, inventory of the pair of shoes, available sizes, etc. The retailers can be listed alphabetically, according to price of the requested item, availability, proximity to the mobile unit 106, or any other suitable manner of organizing a plurality of merchants. Moreover, the information can include an option to purchase the requested item by way of the mobile unit 106 (over the intranet). For instance, a user can scroll to a merchant and select a button or series of buttons that begins effectuation of a purchase, and the user can thereafter select a desired payment method (e.g., credit card, debit card, gift card, etc.). Similarly, if the mobile unit 106 is associated with a pressure sensitive screen, purchase of the item can be initiated through selection of a graphical or textual icon with a stylus. Additionally, voice commands can be employed to initiate a purchase of a requested item. Upon purchasing the item, the user can enter the retail establishment and quickly pick up the purchased item. For example, an electronic receipt can be generated and provided to the mobile unit 106, and such receipt can be quickly displayed at a check-out counter of the merchant from which the item is purchased. Accordingly, the user receives benefits of quickly possessing the item without having to search for the item in multiple stores for availability and without having to compare prices of the item between merchants, as such prices can be immediately provided to the mobile unit 106 upon performance of the search.

Often, however, individuals will wish to inspect the item prior to purchasing the item. Therefore, if the user does not immediately wish to purchase the item (e.g., declines the option to purchase the item), the user can select the provided item from at least one merchant and be provided with a map and/or directions to the physical location of the item. The communication component 104 can provide a general map of a shopping area, highlighting location of the selected merchant amongst a plurality of merchants. In another example, a map can be provided indicating a user's current location with respect to the selected merchant. Moreover, the map can be dynamically updated as the user moves towards the merchant. For example, more granular maps can be generated as the user nears the selected merchant, such that a precise location of the item within the merchant's establishment can be provided to the user (e.g., a particular aisle). Additionally or alternatively, textual directions can be provided to the user by way of the communications component 104, wherein such directions can include directions to the merchant's establishment, an aisle in which the requested item is located, and other suitable directions.

Upon locating the item, the user can purchase the item in a conventional manner by locating a check-out counter and obtaining assistance from a salesperson. The user may also, however, purchase the item through the mobile unit 106. For instance, the merchant and the item can be provided to the user on a graphical user interface of the mobile unit 106, and the user can request to purchase the item by way of such interface. Upon completing the purchase, the user can gather the item and, to mitigate theft, display an electronic receipt to personnel prior to exiting the merchant's establishment. In another example, the item may be associated with an electronic security device that can be disabled upon the user completing the purchase. Thereafter the user can simply exit the retail establishment with the item. In yet another example, the mobile unit 106 can include hardware, such as RFID reading hardware, that enables the mobile unit 106 to effectuate the purchase and provide product identification to a server (not shown). Therefore, inventory can be updated and the user can exit the merchant's establishment with the purchased item. Purchasing an item in this manner provides benefits associated with online purchasing or items as well as in-person purchase of items. In more detail, the user can obtain immediate possession without being forced to spend a significant amount of time searching for items, price checking items, and the like. In still another example, the user can utilize the system 100 to locate a desired item, inspect the desired item, and pay for such item, but utilize the online store for delivery of the item. For example, a user may not urgently need the item or may not have means to transport the item, but nevertheless may wish to inspect the item prior to purchase. Furthermore, paying on-site is associated with fewer security concerns than submitting payment information over a network.

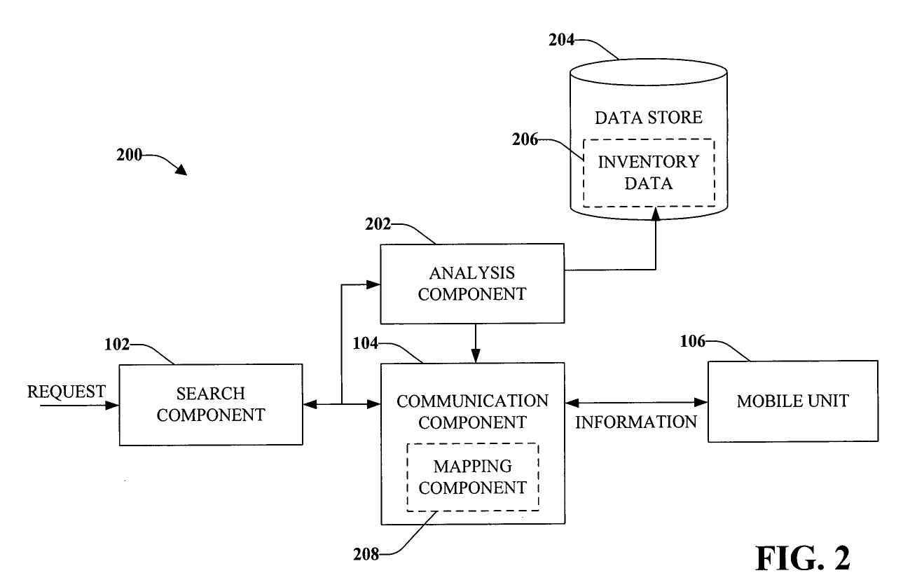

Now referring to FIG. 2, a system 200 that facilitates shopping for items is illustrated. The system 200 includes the search component 102 that receives a request for an item and searches one or more databases that are associated with a plurality of merchants based at least in part upon the request. As described above, the request can include geographic information associated with the mobile unit 106. The search component 102 is communicatively coupled to the communication component 104, which provides a subset of information relating to the requested item that is located by the search component 102 to the mobile unit 106. The system 200 can further include an analysis component 202 that analyzes inventory associated with the requested item and provides results of such analysis to the communication component 104. The communication component 104 can thereafter incorporate the analysis results into the information provided to the mobile unit 106.

More particularly, the analysis component 202 can be associated with a data store 204 that includes inventory data 206, which can be updated periodically or dynamically. For instance, the data store 204 can be associated with inventory systems of a plurality of merchants, such that when items are stocked at a merchant's establishment or removed from the merchant's establishment the inventory data 206 is updated. Pursuant to an example, a user can provide a request to the search component 102 for a particular electronic device. The request can be relayed to the communication component 104 and the analysis component 202. The analysis component 202 can then access the data store 204 and review the inventory data 206 to determine which merchants have the requested item in stock, and if in stock, a number of such items currently available for purchase. The inventory information can then be relayed to the communication component 104. While shown as being separate from the communication component 104 and the search component 102, it is understood that the analysis component 202 can be considered a part of the communication component 104 and/or the search component 102.

The communication component 104 can include a mapping component 208 that can generate one or more maps that indicate location of the requested item and/or directions to the requested item. The maps and/or directions can be provided to the mobile unit 106 by the communication component 104. The mapping component 208 can interrogate the mobile unit 106 to determine display parameters associated therewith and/or can request such indicia from a user of the mobile unit 106. Upon determining display parameters, the mapping component 208 can generate maps and/or directions that are customized based upon the display parameters. For instance, a detailed map may not display clearly on a display with resolution below a threshold. Thus, the mapping component 208 can generate a simple map and/or can provide the mobile unit 106 with text directions to the requested item. As alluded to above, the map and/or directions can be based at least in part upon the geographic information associated with the mobile unit 106 provided in the request. Given the geographic information (and geographic information associated with the merchants and/or the requested item), the mapping component 208 can generate a detailed map and/or directions that enable a user to quickly locate the requested item within a merchant's establishment.

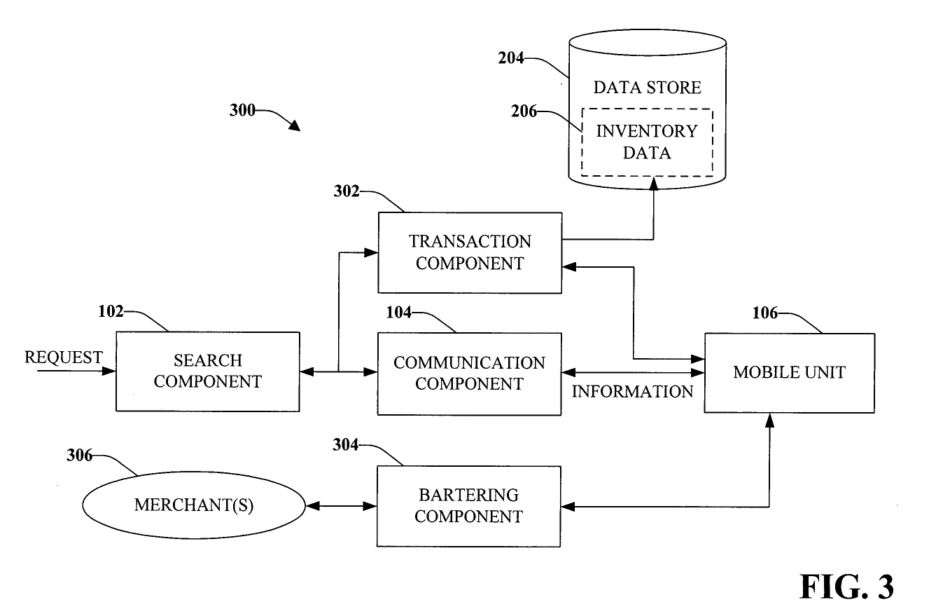

Now referring to FIG. 3, a shopping enhancement system 300 is illustrated. The system 300 includes the search component 102, the communication component 104, and the mobile unit 106, which can operate in conjunction as described above. The system further includes a transaction component 302 that facilitates effectuation of a purchase of a requested item over an intranet. Further, the transaction component 302 can enable the user to purchase the item through the mobile unit 106. For instance, the search component 102 can receive a request for a small appliance, and the search component 102 can search through one or more databases that are associated with a plurality of merchants for information relating to the requested appliance. This located information can be provided to the communication component 104, which can then select a subset of the information and provide such information to the mobile unit 106. Furthermore, the communication component 104 can format the information so that it is presented on the mobile unit 106 in an aesthetically pleasing manner. Such information can include a plurality of merchants that are selling the appliance as well as prices associated with each merchant.

A user can employ interfaces associated with the mobile unit 106 to select one of the merchants as well as indicate that the user desires to purchase the appliance from the selected merchant. This data can be provided to the transaction component 302, which can then request and/or automatically retrieve payment information from the mobile unit 106. The transaction component 302 can be configured to accept and authenticate a plurality of different payment methods, including payment through credit card, debit card, e-check, gift card, electronic cash (cash stored in a mobile unit account), etc. The transaction component 302 can thereafter access the data store 204 and update the inventory data 206 (e.g., to remove the appliance from available items associated with the selected merchant).

The system 300 can further include a bartering component 304 that enables a user to provide counteroffers to one or more selected merchants by way of the mobile unit 106. Continuing with the above example, the communication component 104 can cause a plurality of merchants that offer for sale the requested appliance to be listed on the mobile unit 106, together with prices associated with the appliance. A user, through the mobile unit 106, can select one or more of the merchants and provide a counteroffer to selected merchant(s) 306 through the bartering component 304. For instance, the bartering component 304 can automatically generate an email or text message and deliver it to an appropriate individual or individuals associated with the merchant(s). The merchant(s) 306 may respond in kind, delivering an email or text message to the mobile unit 106 through the bartering component 304.

In another example, if one of the merchant(s) accepts the counteroffer, a sale of an at-issue item can be automatically initiated. If a counteroffer is submitted to a plurality of merchants, a first merchant to accept the counteroffer can be awarded sale of the requested item. In another example, a computing component (not shown) associated with the merchant(s) 306 can automatically provide a response to a counteroffer received through the bartering component 304. This can be accomplished through setting a threshold price and/or through analyzing sales trends associated with the item, inventory related to the item, price to the merchant of the item, expected profit associated with the item, etc. The merchant(s) 306 can then respond to the user through the bartering component 304 quickly and efficiently. If a purchase is finalized, the inventory data 206 within the data store 204 can be updated, for example, by the bartering component 304 and/or the transaction component 302 (which, while not shown, can be communicatively coupled to the bartering component 304).

Furthermore, merchants can provide alternatives to a selected item by way of the bartering component 304. For example, upon receiving a selection of an item to be purchased by a user, a merchant associated with the selected item can respond with such item or may respond with a similar item (including an explanation of differences between the selected item and the similar item). This may be particularly important if the selected/requested item is not in stock or if the merchant, over time, has experienced alteration in user selections when given a choice between two or more items. In a specific example, a user may select canvas hiking boots, while not being aware that such boots are not waterproof and do not retain heat as well as boots made with waterproof material. Accordingly, the merchant can provide the user with similar items for contemplation by the user prior to completing a transaction.

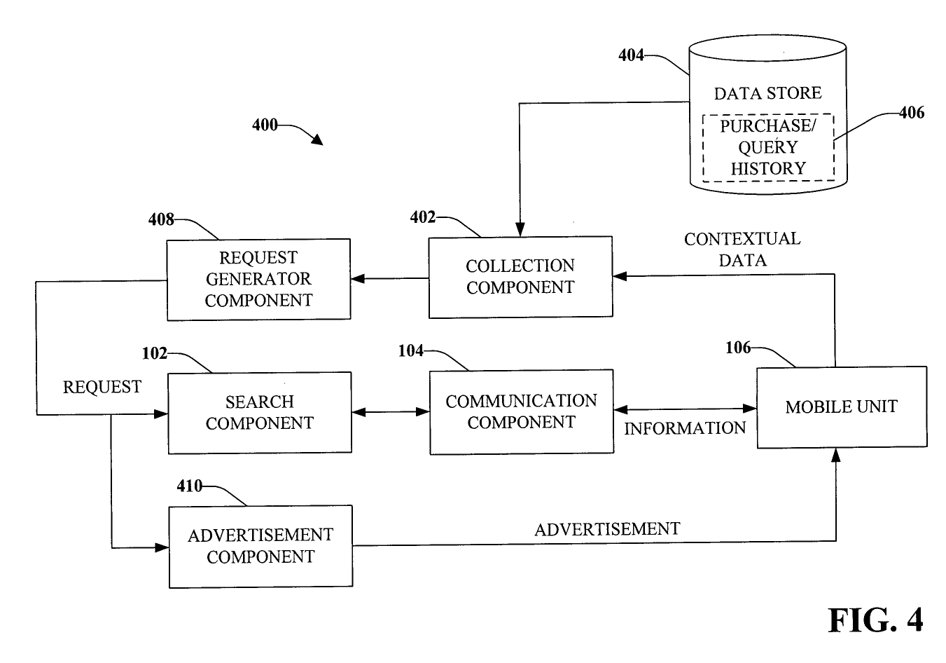

Now referring to FIG. 4, a system 400 that automatically provides a user with information relating to one or more items in a shopping environment is illustrated. The system 400 includes the search component 102, which receives a request relating to an item and searches for information relating to such item. The information can be provided to the communication component 104, which formats at least a subset of the located data and provides it to the mobile unit 106. In one particular example, the request received by the search component 102 can be implicitly generated and automatically provided to such search component 102.

More specifically, the system 400 can include a collection component 402 that receives or collects contextual data from the mobile unit 106, such as physical location of the mobile unit 106, device type, processing capabilities, screen size and resolution, graphics cards associated with the mobile unit 106, and other suitable contextual data associated with the mobile unit 106. Furthermore, the collection component 402 can receive other suitable contextual data, such as time of day, day of week, day of year, shopping season, weather conditions, etc. Still further, the collection component 402 can receive user-centric data from a data store 404, which includes purchase/query history information 406. For example, each purchase made by a user through employment of the mobile unit 106 can be maintained within the data store 404 and associated with a time of purchase. Similarly, queries provided to the search component 102 by a user can be tracked to determine what items interest the user.

Information received by the collection component 402 can be provided to a request generator component 408 that automatically creates a request based at least in part upon the received information. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.) can be employed in connection with performing automatic and/or inferred action. In a particular example, the request generator component 408 can receive data that indicates that winter is approaching, and that the user has last purchased a winter coat two years ago. Moreover, the request generator component 408 can determine that the user is geographically proximate to an outdoor clothing merchant that sells winter coats that are comparable to the last coat purchased by the user. Therefore, the request generator component 408 can automatically generate a request relating to at least one of such coats. The search component 102 can locate information relating to the coat(s), and provide such information to the communication component 104. Thus, a request can be implicitly generated through employment of the collection component 402 and the request generator component 408.

The system 400 further includes an advertisement component 410 that can provide an advertisement to the mobile unit 106 based at least in part upon the request. Continuing with the above example, the advertisement component 410 can determine that the received request is related to winter coats. The advertisement component 410 can then determine that an advertisement related to winter boots may be appropriate to provide to the mobile unit 106. Relationships between content of requests and subject matter of advertisements can be explicitly defined in a database and/or determined by way of inference. For example, the advertisement component 410 can infer that the user may be interested in other items associated with stores that sell a requested item. One or more advertisements associated with such items can then be provided to the mobile unit 106. Moreover, while FIG. 4 depicts the advertisement component 410 providing an advertisement to the mobile unit 106 based upon an implicitly created request, it is understood that such component 410 can also be employed in connection with explicitly (user created) requests.

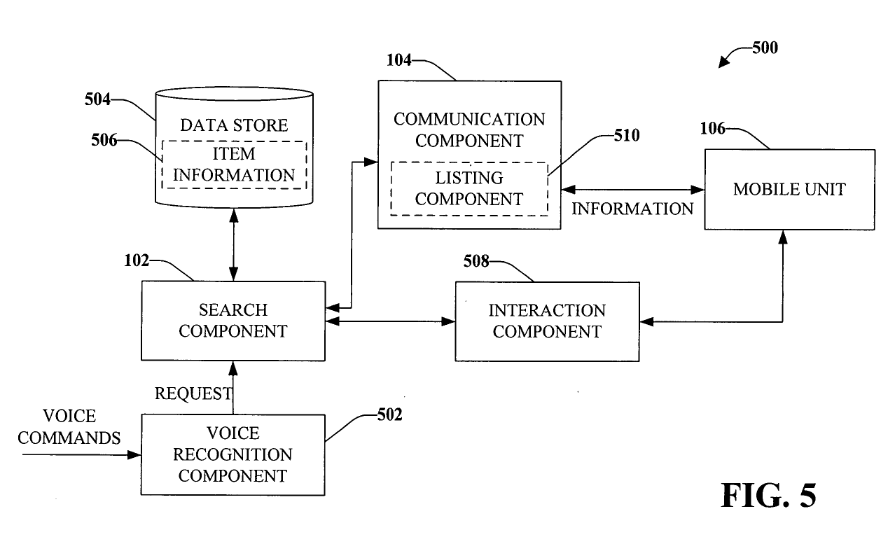

Now referring to FIG. 5, a system 500 that facilitates shopping is illustrated. The system 500 includes a voice recognition component 502 that receives voice commands and translates them into a request that can be interpreted by the search component 102. For example, the voice recognition component 502 can include one or more trained classifiers that aids in translating voice commands to a Boolean query, a binary string, or the like. The search component 102 can then search a data store 504 that includes item information 506 for details relating to an item specified within the request. Generating requests for items, however, may be difficult for some users. For example, certain users may find it problematic to create a request with appropriate specificity. Thus, an interaction component 508 can be provided to prompt a user to provide a more or less specific request. In a detailed example, a request received by the search component 102 can be for “shoes.” Upon searching the data store 504, the search component 102 can determine that there exist far too many types of shoes to display upon the mobile unit 106. The interaction component 508 can then provide queries to the user through the mobile unit 106 (or device utilized to initiate the request), such as “what type of shoes,” “what size of shoes,” “what brand of shoes,” and any other suitable questions that facilitate receipt of sufficient information to provide to the search component 102. In another example, selectable icons can be provided to the user to aid in receiving sufficient information to provide to the search component 102. The search component 102 can re-search the data store 504 upon receipt of additional information from the interaction component 508 until suitable information is retrieved.

The located information relating to one or more items specified within the request (or through the interaction component 508) can be provided to the communication component 104. The communication component 104 can include a listing component 510 that lists one or more merchants that are associated with the requested items. For example, a plurality of merchants in a geographic range can sell similar products. The listing component 510 can cause the merchants to be listed in a desirable order. For instance, the listing component 510 can list the merchants according to proximity of the merchants to the mobile unit 106 (e.g., a merchant that is closest to the mobile unit can be listed most prominently). In another example, the listing component 510 can list the merchants in alphabetical order, according to price levels associated with the merchants (e.g., a merchant associated with a lowest price can be displayed most prominently), or user preferences. For instance, a merchant most preferred by the user can be listed above other merchants. It can thus be discerned that any suitable manner for listing merchants associated with the request is contemplated and intended to fall within the scope of the hereto-appended claims.

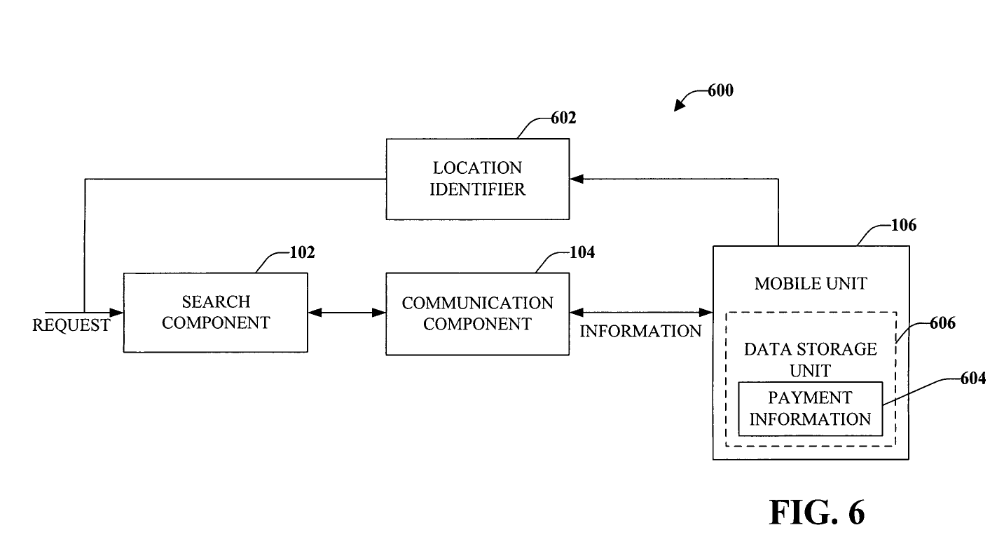

Turning now to FIG. 6, a system 600 that facilitates location and purchase of one or more items is illustrated. The system 600 includes the search component 102 that receives a request relating to an item and searches one or more databases for information relating to the item. The database(s) can include, for example, inventory data for a plurality of merchants. In one example, the request can include geographic indicia associated with the mobile unit 106. In more detail, a location identifier 602 can be utilized to determine geographic location of the mobile unit 106, and the determined location can be incorporated within the request (which may originate from the mobile unit 106). For example, the mobile unit 106 may be associated with GPS capabilities, which enables the location identifier 602 to determine an approximate latitude and longitude associated with the mobile unit 106. This geographic data can be incorporated within the request, such that the search component 102 limits a search to merchants within a particular geographic range of the mobile unit 106. In one particular example, the search can be limited to merchants within a two mile radius of the determined location of the mobile unit 106. In accordance with another feature, a cellular tower that is communicating with the mobile unit 106 can be identified by the location identifier 602 to determine an approximate location of the mobile unit 106. In still another example, the location identifier 602 can be associated with triangulation algorithms to approximate the geographic location of the mobile unit 106. In more detail, if the mobile unit 106 can communicate with at least three disparate antennas, then time of arrival between the antennas and the mobile unit 106 can be estimated and utilized to approximate a location of the mobile unit 106. Further, the location identifier 602 can identify WiFi points and determine geographic location of the mobile unit 106 based upon such points. It can thus be understood that any suitable manner for determining or approximating geographic location of the mobile unit 106 may be used.

The mobile unit 106 can be employed to consummate a purchase of a requested item through utilization of payment information 604 that can be stored locally within a data storage unit 606. The payment information 604 can include credit card information, such as card number, cardholder name, expiration date, address associated with the account, security number, and other suitable data that may be required to consummate a purchase. The payment information 604 can also include debit card information, checking account information, savings account information, gift card information, or other suitable payment methods/mechanisms. The user can indicate that they desire to purchase a requested item by selecting a merchant on a graphical user interface of the mobile unit 106, where the merchant is indicated as offering the item for sale. The user can then select a desired payment method and quickly and easily effectuate the purchase. To reduce security concerns, a password, personal identification number, or the like can be required before undertaking a purchase. Further, biometric indicia, such as a fingerprints and/or voice data, can be analyzed prior to allowing a purchase to be consummated through the mobile unit 106.

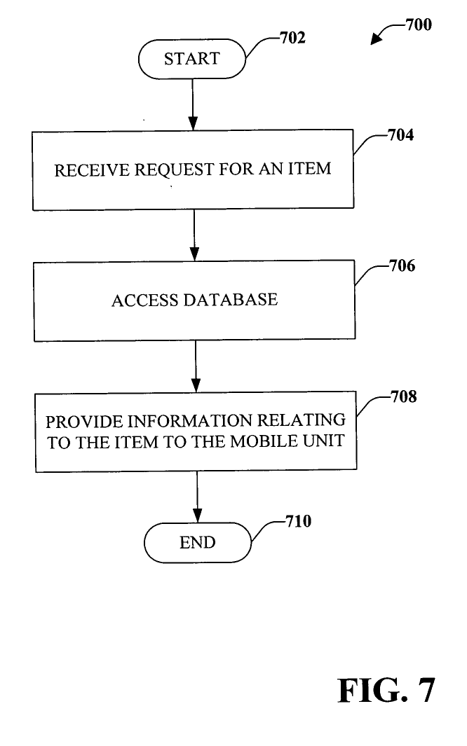

Referring now to FIGS. 7-10, methodologies in accordance with the claimed subject matter will now be described by way of a series of acts. It is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring specifically to FIG. 7, a methodology 700 for providing information to a mobile unit relating to a requested item in a retail environment is illustrated. The methodology 700 begins at 702, and at 704 a request for a product or service (an item) is received over an intranet. The request can be provided explicitly by a user and/or implicitly generated based at least in part upon contextual data and/or user history. Furthermore, the request can be associated with current geographic location of a mobile unit and/or future geographic location of the mobile unit. This enables the request to be provided to a plurality of merchants that are within a particular distance from the current and/or prospective location of a user.

At 706, a database that includes identification of a plurality of merchants, geographic information associated with the plurality of merchants, and items that that are associated with the plurality of merchants is accessed. Content of such database can then be searched based upon the request. As the request is associated with a geographic location, a search for the item can be confined to a particular distance from the mobile unit. For example, the distance can be defined by a user, restricted to walking distance of a user, restricted to a particular shopping region, etc. At 708, information relating to the item is provided to the mobile unit based at least in part upon content of the request, wherein the information can include merchants offering a requested item for sale and location thereof, pricing information, inventory information, maps and/or directions associated with the requested item, etc. Furthermore, a user can be provided with an option to purchase the requested item through the mobile unit. For instance, the user can utilize the mobile unit to purchase the requested item and then quickly travel to the store to pick up such item. Alternatively, the user can (through use of information provided to the mobile unit) travel to a merchant's establishment and inspect the requested item prior to purchasing such item. Thus, benefits of online shopping and traditional shopping can be combined through utilization of the methodology 700. The methodology completes at 710.

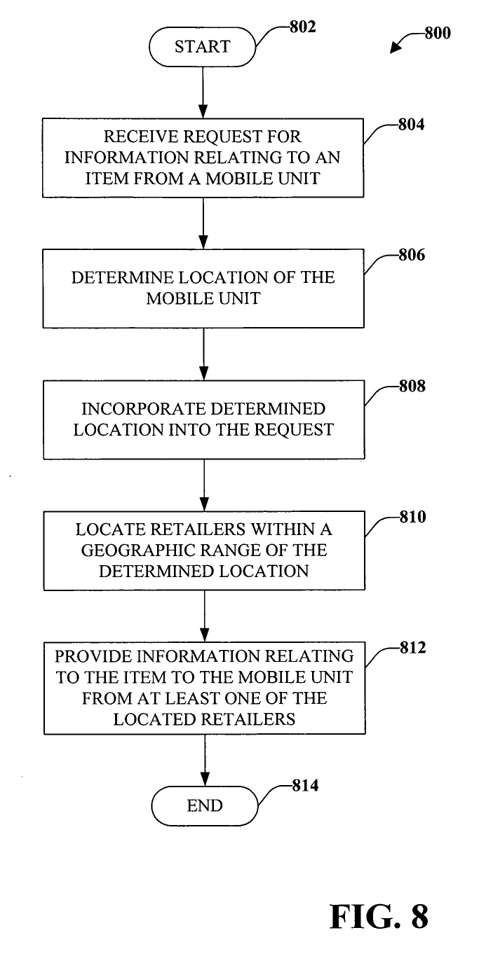

Referring now to FIG. 8, a methodology 800 for providing information relating to a desirably purchased item is illustrated. The methodology 800 initiates at 802, and at 804 a request for information relating to an item is received from a mobile unit over an intranet. For example, the mobile unit can be a personal digital assistant, a mobile telephone, a text messaging device, an instant messaging device, a laptop computer, a portable web-browsing device, or any other suitable portable device. The intranet can be employed to receive and maintain data relating to a plurality of merchants that are geographically proximate to one another, such as in a shopping mall, a collection of outlet stores, and the like. At 806, location of the mobile unit is determined. As described above, any suitable manner to determine location of the mobile unit is contemplated and intended to fall under the scope of the hereto-appended claims, including identification of a WiFi hotspot accessed by the mobile unit, GPS functionality, triangulation algorithms, etc.

At 808, the determined location is incorporated into the request, thereby associating the request with the location of the mobile unit. At 810, one or more merchants within a particular geographic range of the mobile unit are located. Pursuant to one example, each merchant associated with the intranet may be within the geographic range. Thus, for instance, each merchant at a shopping mall can be located, and inventory associated therewith can be searched based upon the request. At 812, information relating to the requested item can be provided to the mobile unit from at least one of the located retailers, wherein such information can be provided by way of the intranet. The information can include price of a requested item with respect to each of a plurality of merchants that offer the item for sale. Similarly, the information can include a map and/or directions to the merchant in general and/or to the requested item in particular. Thus, a user of the mobile unit can quickly locate a desired item while at a shopping center to enable on-site inspection of the item prior to purchase. The methodology completes at 814.

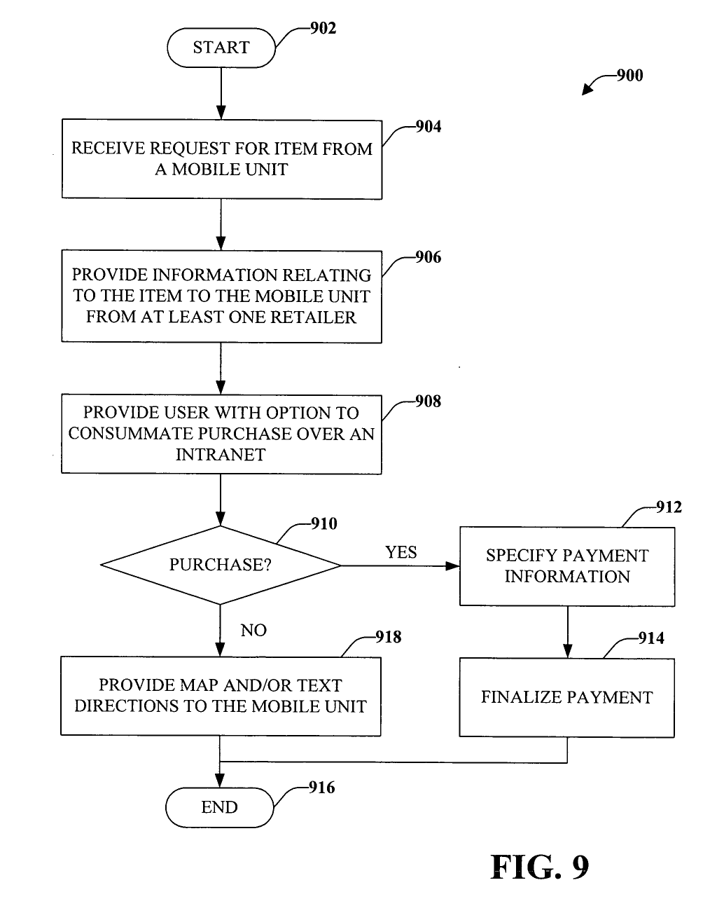

Referring now to FIG. 9, a methodology 900 for aiding a user in connection with shopping for one or more items is illustrated. The methodology 900 initiates at 902, and at 904 a request for an item from a mobile unit is received by way of an intranet. The item can be an item that is desirably inspected and/or purchased by a user of the mobile unit, and can be offered for sale by one or more merchants. At 906, information relating to the requested item from at least one merchant is provided to the mobile unit, wherein the information can include identity of the at least one merchant, inventory of the item with respect to the at least one merchant, and/or pricing information associated with the at least one merchant. At 908, a user is provided with an option to consummate the purchase by way of the intranet through utilization of the mobile unit. For example, a selectable graphical icon can be provided to the user that initiates purchase of a particular item from a selected retailer. In another example, instructions can be provided on a graphical user interface of the mobile unit regarding buttons to depress to initiate a purchase.

If a user wishes to purchase the requested item from a specified merchant, payment information is specified at 912, wherein such payment information can be provided to a transaction server or other suitable component that facilitates purchase of the item. The payment information can include credit card information, debit card information, gift card information, or any other suitable information. At 914, the payment is finalized, and the methodology completes at 916. If the user does not desire to purchase the item by way of the mobile unit, a map and/or text directions can be generated and provided to the mobile unit. Directions provided to the mobile unit can be general in nature, such as informing a user how to locate a particular merchant from various directions or locations. In another example, the directions and/or maps provided to the mobile unit can be specific in that the user can be informed how to travel from a current location to the selected item. The methodology 900 can then complete at 916.

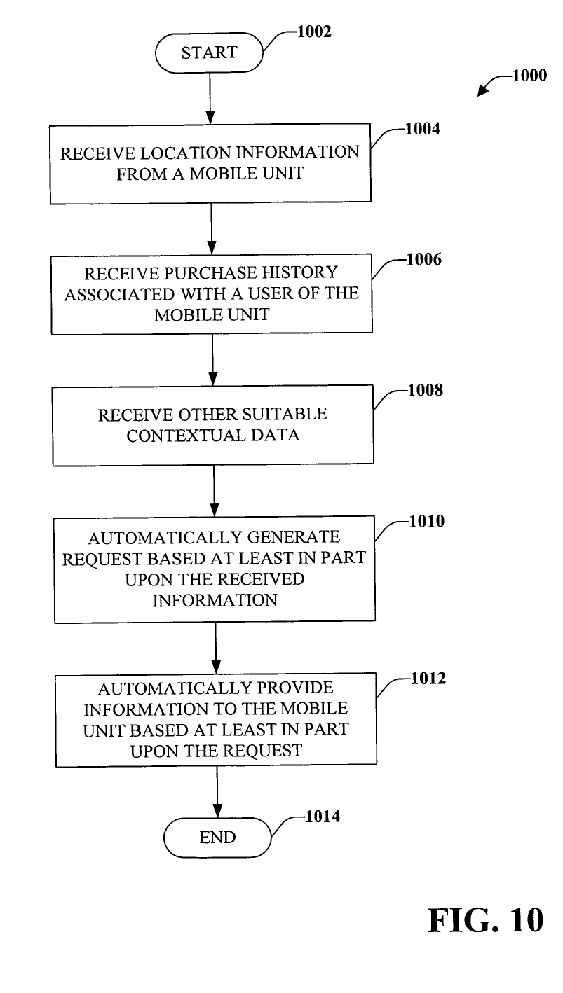

Now turning to FIG. 10, a methodology 1000 for enhancing a user's shopping experience is illustrated. The methodology 1000 begins at 1002, and at 1004 a location of a mobile unit is received. For example, the mobile unit can automatically associate itself with a server associated with a shopping center as it becomes geographically proximate to such center. Thus, a general location of the mobile unit can be determined. At 1006, purchase history associated with a user of the mobile unit is received, wherein such history can be a global purchase history and/or purchase history associated with a select plurality of merchants. For instance, transaction descriptions associated with one or more specified accounts can be analyzed to obtain a global purchase history. At 1008, other suitable contextual data is received, such as time of day, time of year, weather conditions. At 1010, a request is automatically generated based at least in part upon the received information (e.g., the location of the mobile unit, the purchase history, and the contextual data). In one example, analysis of purchase history can result in a determination that a user has not purchased a mobile telephone plan for nearly one year, and that a current plan of the user is nearly expired. The generated request can thus be directed to mobile phone plan providers that are geographically proximate to the user.

At 1012, information is automatically provided to the mobile unit based at least in part upon the request. For instance, a mobile unit can vibrate or generate an audible output to indicate to the user that information has been received. A cost-benefit analysis can be automatically undertaken when determining whether to provide the information to the user and how to provide the user with the information. For example, if the user is speaking on a mobile phone, it may be undesirable to interrupt a conversation with an audible alert. The methodology 1000 then completes at 1014.

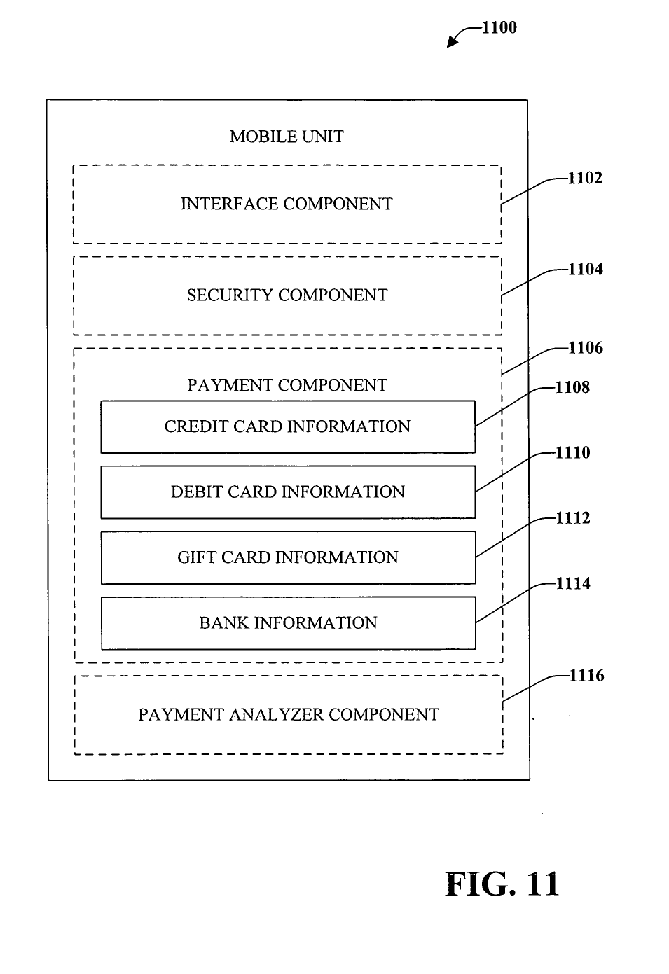

Now referring to FIG. 11, an exemplary mobile unit 1100 that can be employed in connection with dynamically receiving information relating to a desirably reviewed and/or purchased item is illustrated. In particular, the mobile unit 1100 can be employed to purchase an item and/or receive information relating to the item. The mobile unit 1100 can include an interface component 1102 that enables a user to communicate with one or more servers through an intranet. For example, the interface component 1102 can include a graphical user interface, one or more depressible keys, a microphone, a speaker, and any suitable software that facilitates electronic communications. The mobile unit 1100 can further include a security component 1104 that can be employed to reduce concerns relating to theft of the mobile unit 1100 and illegal purchase of items through the mobile unit 1100. For example, the security component 1104 can receive and authenticate one or more usernames, passwords, and/or personal identification numbers. Further, the security component 1104 can be associated with hardware and/or software that enables such component 1104 to determine identity of a user through biometric indicia. In a detailed example, the security component 1104 can include a scanning device that can be employed to receive and analyze fingerprint information. Similarly, the security component 1104 can include voice recognition software that can authenticate a user given certain voice samples.

Upon receiving an indication that a purchase is desirably consummated by way of the interface component 1102 and authenticating user identity through the security component 1104, a payment component 1106 can be employed to effectuate such purchase. For example, the payment component 1106 can include credit card information 1108, debit card information 1110, gift card information 1112, banking information 1114, and/or any other suitable information that enables a user to provide monies to a merchant for a purchased item. Thus, the user can select one of a plurality of possible payment methods through the interface component 1102, and can submit payment information over an intranet to a merchant for authentication. The mobile unit 1100 can also include a payment analyzer component 1116 that aids a user in selecting an optimal payment method given known financial data associated with the user. For example, the credit card information 1108 can include current balance associated with one or more credit cards, interest rates associated with credit cards, payment due dates relating to credit cards, and the like. Similarly, the debit card information 1110 can include balance of a checking account, interest associated with the checking account, and the like. The payment analyzer component 1116 can analyze payment methods available to the user and provide one that it deems to be the best available payment method. For example, the payment analyzer component 1116 can recommend that the user purchase the item with a particular credit card due to a lower interest rate and/or certain rewards associated with the card.

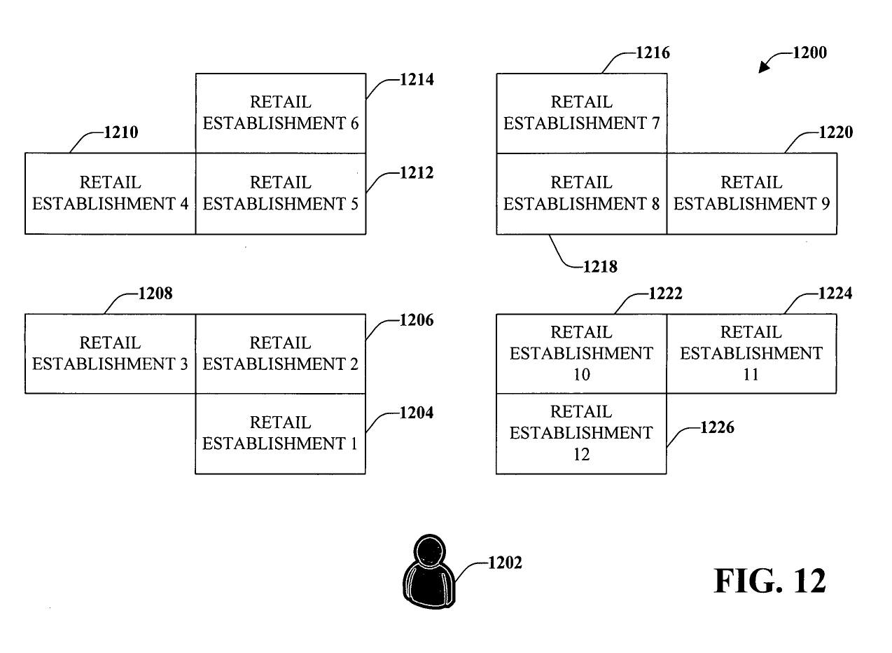

Referring now to FIG. 12, an exemplary shopping environment 1200 where one or more aspects described herein can be employed is illustrated. The environment 1200 can be a shopping center, for example, that includes a plurality of retail establishments that can offer various items for sale. Often, however, several retail establishments in a shopping center offer substantially similar items for sale. Conventionally, a user would be forced to enter several retail establishments searching for and pricing desired items. Utilizing aspects described herein, such deficiencies can be overcome. For instance, a user 1202 can enter the shopping environment 1200 with a mobile unit. The shopping environment 1200 illustrated herein includes twelve different retail establishments 1204-1226, wherein some of the retail establishments 1204-1226 can sell items of a same type. It is understood, however, that any suitable number of retail establishments can be associated with the features described herein. Furthermore, each of the retail establishments 1204-1226 can be associated with an intranet, wherein such intranet can include location of each of the retail establishments 1204-1226, items offered for sale by the retail establishments 1204-1226, prices of the items, inventory, and other suitable data.

The user 1202 can utilize the mobile unit to access the intranet and provide a request for a particular item that may be offered for sale by at least one of the retail establishments 1204-1226. For instance, the user can enter a request for a particular video game. The mobile unit can then be provided with information relating to which retail establishments are currently offering the video game for sale, available inventory, and/or directions to the retail establishments. In a particular example, the fifth retail establishment 1212 and the ninth retail establishment 1220 can both provide the requested video game for sale. The mobile unit can be provided with the name of such retail establishments, their location with respect to the user 1202, and/or pricing information relating to the video game. The user can select one of such retail establishments to effectuate purchase of the item by way of the mobile unit and/or to retrieve additional information relating to the selected retail establishment. Thus, rather than being forced to randomly search through a plurality of the retail establishments 1204-1226 for a desired item, a location and price of such item can be quickly provided to the user.

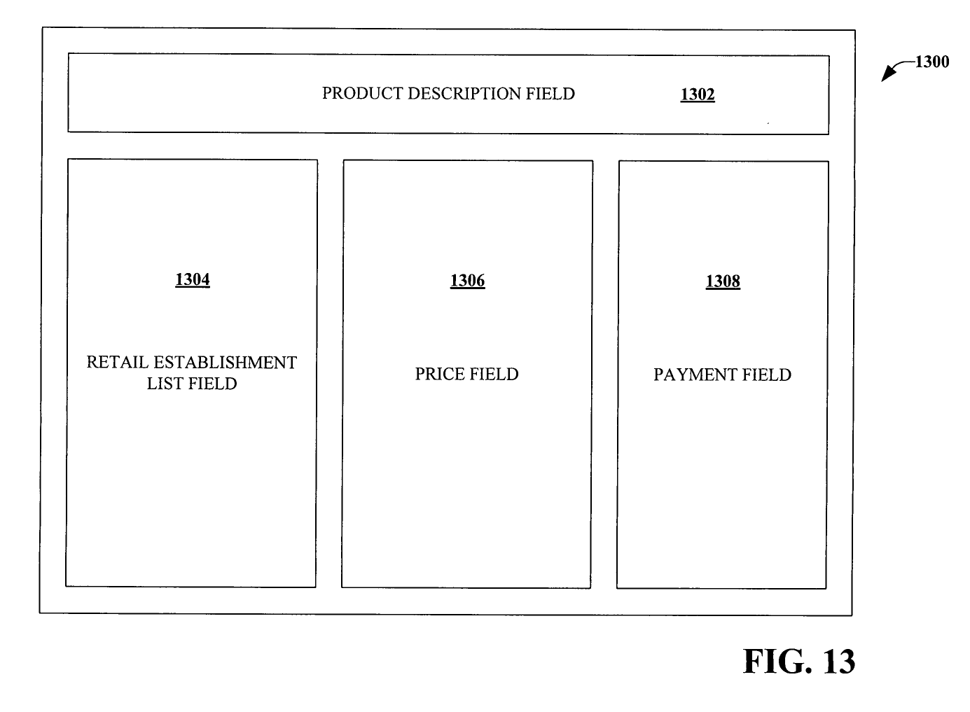

Turning now to FIG. 13, an exemplary user interface 1300 that can be provided to a mobile unit to facilitate shopping is illustrated. The interface 1300 can be provided to a user after a request for an item has been received. The interface 1300 includes a product description field 1302 that can include a description of the product, thereby enabling the user to quickly authenticate that a desired item has been selected. A merchant list field 1304 can include one or more merchants that are offering the requested item for purchase within a particular geographic range of the user. Additionally or alternatively, the merchants listed in the merchant list field 1304 can each be associated with an intranet that is accessed by a mobile unit that displays the interface 1300. A price field 1306 can include a list of prices for the item with respect to merchants in the merchant list field 1304. Therefore, a user can quickly determine which merchant that is offering the item for sale is associated with a lowest price. A payment field 1308 can be included within the graphical user interface 1300, wherein such field 1308 can include selectable icons that initiate purchase of the item from a selected merchant by way of the mobile unit. While specific display fields have been shown and described in the user interface 1300, it is understood that such interface 1300 is exemplary and that type and location of display fields can be altered while remaining in accordance with the claimed subject matter.

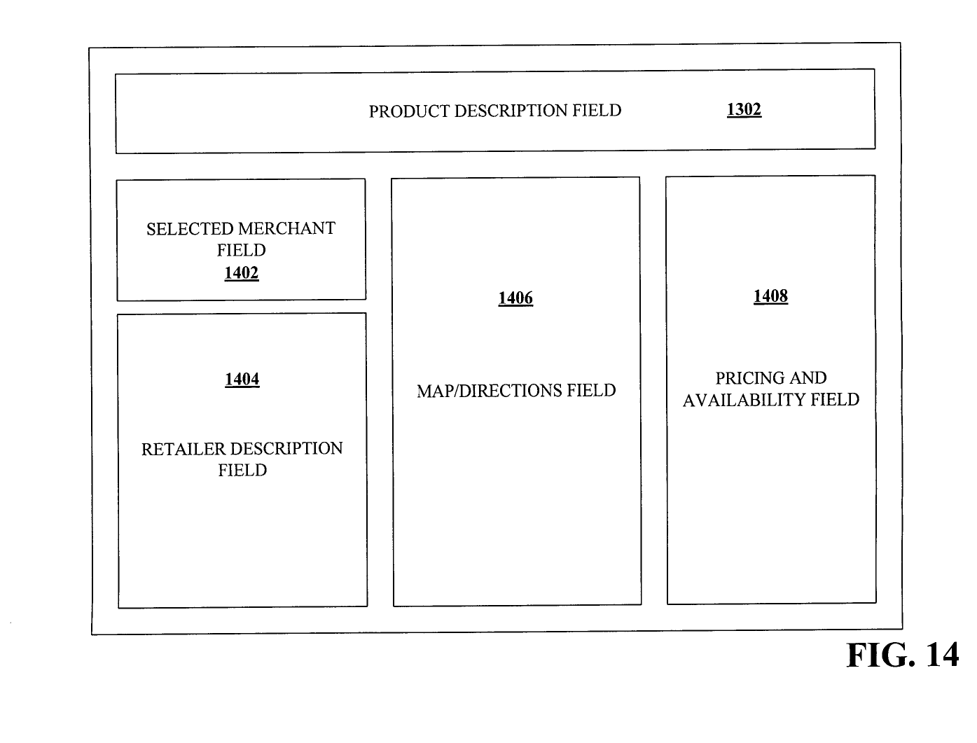

Now turning to FIG. 14, another exemplary user interface 1400 is illustrated. The user interface 1400 includes the product description field 1302, and can further include a selected merchant field 1402. For instance, if a user selects a merchant in the graphical user interface 1300 (FIG. 13) but does not wish to purchase the item, such selected merchant can be displayed in the selected merchant field 1402. A merchant description field 1404 can include a description of the merchant displayed in the selected merchant field 1402, such as items in which the retailer specializes. The graphical user interface 1400 can also include a map/directions field 1406 that displays a map that indicates location of the selected merchant with respect to the user and/or directions to the selected retailer from the user's current location. The graphical user interface 1400 can further include a pricing and availability field 1408 that displays pricing information associated with the requested item and/or availability of the item at the selected merchant.

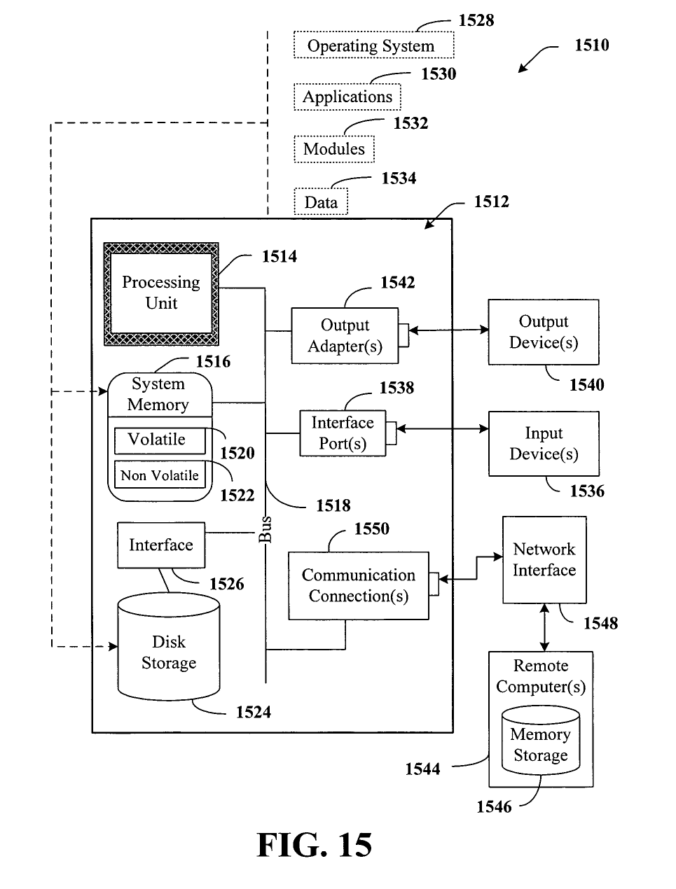

In order to provide additional context for various aspects of the subject invention, FIG. 15 and the following discussion are intended to provide a brief, general description of a suitable operating environment 1510 in which various aspects of the claimed subject matter may be implemented. While the claimed subject matter is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1510 is only one example of a suitable operating environment and is not intended to suggest any limitation as to the scope of use or functionality of the features described herein. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 15, an exemplary environment 1510 that can be employed in connection with providing information relating to a desirably purchased item to a user includes a computer 1512. The computer 1512 includes a processing unit 1514, a system memory 1516, and a system bus 1518. The system bus 1518 couples system components including, but not limited to, the system memory 1516 to the processing unit 1514. The processing unit 1514 can be any of various available processors. Dual microprocessors and other multiprocessor architectures also can be employed as the processing unit 1514.

The system bus 1518 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI). The system memory 1516 includes volatile memory 1520 and nonvolatile memory 1522. The basic input/output system (BIOS), containing the basic routines to transfer information between elements within the computer 1512, such as during start-up, is stored in nonvolatile memory 1522. By way of illustration, and not limitation, nonvolatile memory 1522 can include read only memory (ROM), programmable ROM (PROM), electrically programmable ROM (EPROM), electrically erasable ROM (EEPROM), or flash memory. Volatile memory 1520 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1512 also includes removable/nonremovable, volatile/nonvolatile computer storage media. FIG. 15 illustrates, for example a disk storage 1524. Disk storage 1524 includes, but is not limited to, devices like a magnetic disk drive, floppy disk drive, tape drive, Jaz drive, Zip drive, LS-100 drive, flash memory card, or memory stick. In addition, disk storage 1524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). For instance, a DVD-ROM drive can be employed in connection with reading video content from a DVD. To facilitate connection of the disk storage devices 1524 to the system bus 1518, a removable or non-removable interface is typically used such as interface 1526.

It is to be appreciated that FIG. 15 describes software that acts as an intermediary between users and the basic computer resources described in suitable operating environment 1510. Such software includes an operating system 1528. Operating system 1528, which can be stored on disk storage 1524, acts to control and allocate resources of the computer system 1512. System applications 1530 take advantage of the management of resources by operating system 1528 through program modules 1532 and program data 1534 stored either in system memory 1516 or on disk storage 1524. It is to be appreciated that the subject invention can be implemented with various operating systems or combinations of operating systems.

A user enters commands or information into the computer 1512 through input device(s) 1536. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, remote control, and the like. As described above, advertisements can be provided to a user upon receipt of user input. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536. Thus, for example, a USB port may be used to provide input to computer 1512, and to output information from computer 1512 to an output device 1540. Output adapter 1542 is provided to illustrate that there are some output devices 1540 like monitors, speakers, and printers among other output devices 1540 that require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a personal computer, a server, a router, a network PC, a workstation, a microprocessor based appliance, a peer device or other common network node and the like, and typically includes many or all of the elements described relative to computer 1512. For purposes of brevity, only a memory storage device 1546 is illustrated with remote computer(s) 1544. Remote computer(s) 1544 is logically connected to computer 1512 through a network interface 1548 and then physically connected via communication connection 1550. Network interface 1548 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1550 refers to the hardware/software employed to connect the network interface 1548 to the bus 1518. While communication connection 1550 is shown for illustrative clarity inside computer 1512, it can also be external to computer 1512. The hardware/software necessary for connection to the network interface 1548 includes, for exemplary purposes only, internal and external technologies such as, modems including regular telephone grade modems, cable modems and DSL modems, ISDN adapters, and Ethernet cards.

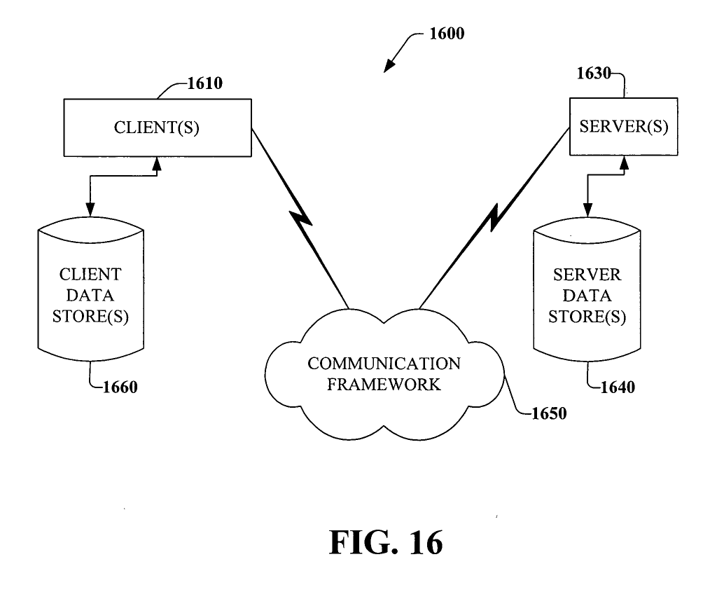

FIG. 16 is a schematic block diagram of a sample-computing environment 1600 with which the claimed subject matter can interact. The system 1600 includes one or more client(s) 1610. The client(s) 1610 can be hardware and/or software (e.g., threads, processes, computing devices). The system 1600 also includes one or more server(s) 1630. The server(s) 1630 can also be hardware and/or software (e.g., threads, processes, computing devices). The servers 1630 can house threads to perform transformations by employing the claimed subject matter, for example. One possible communication between a client 1610 and a server 1630 can be in the form of a data packet adapted to be transmitted between two or more computer processes. The system 1600 includes a communication framework 1650 that can be employed to facilitate communications between the client(s) 1610 and the server(s) 1630. The client(s) 1610 are operably connected to one or more client data store(s) 1660 that can be employed to store information local to the client(s) 1610. Similarly, the server(s) 1630 are operably connected to one or more server data store(s) 1640 that can be employed to store information local to the server(s) 1630. In one particular example, the client(s) 1610 can be employed to generate a request for a particular item in a shopping environment, while the server(s) 1630 can be utilized to provide information to the client(s) 1610 based upon the request. For instance, communications between the client and the server can occur over an intranet.

What has been described above includes examples of the claimed subject matter. It is, of course, not possible to describe every conceivable combination of components or methodologies for purposes of describing such subject matter, but one of ordinary skill in the art may recognize that many further combinations and permutations are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for communicating information relating to an item to a mobile unit comprising the following computer-executable components:
a search component that receives a request relating to the item from the mobile unit over an intranet and searches inventory of a plurality of merchants for information relating to the item; and
a communication component that provides a subset of the information relating to the item and an option to consummate purchase of the item to the mobile unit, the subset of information includes details associated with physical location of the item.

2. The system of claim 1, the communication component comprises a mapping component that provides the mobile unit with a map that identifies physical location of the item upon receiving an indication that a purchase is to be undertaken at the location of the item.

3. The system of claim 2, the mapping component provides directions from a current location of the mobile unit to the physical location of the item.

4. The system of claim 1, further comprising a transaction component that facilitates purchase of the item over the intranet through the mobile unit.

5. The system of claim 1, further comprising an analysis component that analyzes inventory associated with the item, the information is provided to the mobile unit based at least in part upon the analysis.

6. The system of claim 1, further comprising a bartering component that enables provision of a counteroffer to at least one merchant that is offering the item for sale.

7. The system of claim 1, further comprising an advertising component that provides at least one advertisement to the mobile unit based at least in part upon content of the request.

8. The system of claim 1, further comprising:
a collection component that receives one or more of purchase history of a user associated with the mobile unit and contextual data relating to the mobile unit; and
a request generator component that automatically generates the request based at least in part upon the one or more of the purchase history and the contextual data and provides the request to the search component.

9. The system of claim 1, further comprising a refinement component that interacts with a user to refine the request.

10. The system of claim 1, further comprising a voice recognition component that receives voice data and converts the voice data to the request, wherein the request can be interpreted by the search component.

11. The system of claim 1, further comprising a listing component that lists a plurality of retailers within a particular geographic region that offer the item for sale.

12. The system of claim 1, the mobile unit includes a data storage component that comprises payment information including at least one of credit card information, debit card information, checking account information, savings account information, and gift card information, purchase of the item is effectuated through the mobile unit by way of the payment information.

13. The system of claim 1, the mobile unit is at least one of a portable telephone, a personal digital assistant, a smart phone, a mobile instant messaging device, a mobile text messaging device, a computing device attached to an automobile, and a laptop computer.

14. The system of claim 1, further comprising a location identifier that determines geographic location of the mobile unit and includes the geographic location within the request, the information relating to the item that is provided to the mobile unit is associated with the geographic location of the mobile unit.

15. A methodology for providing retail information to a user comprising the following computer-executable acts:
receiving a request associated with an item over an intranet from a mobile unit, wherein the request is associated with a geographic location;
accessing a database that includes identification of a plurality of merchants, geographic information associated with each of the plurality of merchants, and items that are associated with the plurality of merchants; and
providing information from the database that is associated with the item to the mobile unit based at least in part upon content of the request.

16. The methodology of claim 15, further comprising:
determining location of the mobile unit;
including the determined location within the request; and
providing the information based at least in part upon the determined location.

17. The methodology of claim 15, further comprising:
receiving contextual information associated with the mobile unit;
incorporating the contextual information within the request; and
providing the information based at least in part upon the contextual information.

18. The methodology of claim 15, further comprising automatically providing an advertisement to the user based at least in part upon content of the request.

19. The methodology of claim 15, further comprising:
dynamically determining location of the mobile unit; and
dynamically updating the information based at least in part upon the determined location.

20. A system that facilitates provision of information to a mobile unit, comprising:
means for receiving a request relating to at an item; and
means for dynamically providing information to the mobile unit relating to the item, wherein the information relates to one of a plurality of merchants that are within a pre-defined geographic range of the mobile unit.
